(19) United States
(12) Patent Application Publication
(10) Pub. No.: US 2007/0062627 A1
(43) Pub. Date: Mar. 22, 2007

(54) Pneumatic tire for a vehicle

(76) Inventor: Kay Wagner, Uetze (DE)

Correspondence Address: GREENBLUM & BERNSTEIN, P.L.C., 1950 ROLAND CLARKE PLACE, RESTON, VA, 20191, US

(21) Appl. No.: 10/572,355

(22) PCT Filed: Aug. 25, 2004
(86) PCT No.: PCT/EP04/51895

§ 371 Date: Mar. 16, 2006

(30) Foreign Application Priority Data
Sep. 20, 2003 (DE) 10343599.9

(51) Int. Cl. B60C 17/00

(52) U.S. Cl. 152/517; 152/555

(57) ABSTRACT

Vehicle pneumatic tire in radial design comprising a profiled tread (1), a multi-layered belt assembly (2), an inner layer (4), a casing (3) embodied in at least one layer, which casing is guided around bead cores (6) in bead areas, side walls (8) and for each side wall (8) at least one reinforcing profile (9) which is inserted in the region thereof, is crescent-shaped in cross section, extends respectively at least over a large part of the side wall length and is made of elastomeric materials of different hardnesses. A core profile (10), also with a crescent-shaped cross section, which core profile is made of a harder material than the other material of the reinforcing profile (9), is enclosed in the reinforcing profile (9).

The invention relates to a vehicle pneumatic tire in radial design comprising a profiled tread, a multi-layered belt assembly, an inner layer, a casing embodied in at least one layer, which casing is guided around bead cores in bead areas, side walls and for each side wall at least one reinforcing profile which is inserted in the region thereof, is crescent-shaped in cross section, extends respectively at least over a large part of the side wall length and is made of elastomeric materials of different hardnesses.

Such vehicle pneumatic tires which are self-supporting in case of a breakdown have already been known for some time in different embodiments. The reinforcing profiles installed in the region of the side walls of the tire are embodied in terms of their cross-sectional shape and various properties of their elastomeric mixture such that they are capable of maintaining the tire in a self-supporting manner for a certain time or a certain mileage in case of a sudden loss of pressure, i.e., in a breakdown, so that it is possible to continue driving. A self-supporting tire of the type mentioned at the outset is known, e.g., from DE-A-29 43 654. The tire is provided in the region of its side walls with respectively one reinforcing profile, made of one or more parts and somewhat crescent-shaped, that is arranged between the inner layer and the casing ply and runs to below the belt and to the vicinity of the bead areas. From WO-A-01/43995 a self-supporting tire is known in which each side wall is provided with a reinforcing profile which, over its cross section, is made of layers of a more flexible material and a stiffer material. Each reinforcing profile is thus composed of a plurality of layers essentially oriented in the tire transverse direction. U.S. Pat. No. 4,287,924 shows an embodiment of a self-supporting tire in which two reinforcing profiles embodied in a crescent-shaped manner are provided per side wall, which profiles are respectively inserted between the inner layer and the casing ply, whereby the reinforcing profile adjacent to the casing ply is made of a more flexible, softer elastomer material than that adjoining said profile and the inner layer of the tire. U.S. Pat. No. 5,526,862 shows other embodiments of a self-supporting tire. Here the reinforcing profile introduced in the region of each side wall between the airtight inner layer and the casing covers on one side an elastomeric core inserted in the region of the thickest part of the reinforcing profile, the other side of which core is adjacent to the inner layer of the tire. The modulus of elasticity of the elastomeric material of the reinforcing profile is lower than that of the core. As a result, it should be possible to manufacture the reinforcing profile of a comparatively soft material in order to improve the driving comfort of the tire under normal driving conditions.

Reinforcing profiles or parts of reinforcing profiles made of a rather hard mixture are required to ensure the self-supporting capability of the tire for operation after a breakdown and are therefore embodied in a correspondingly solid manner in the known constructions. This has the effect that the reinforcing profiles or parts of reinforcing profiles made of a hard mixture can buckle or break during operation after a breakdown, in particular with laterally acting forces.

It is thus the object of the invention to counteract this and to prevent a buckling or breaking of the reinforcing profiles.

The object according to the invention is attained in that a core profile that also has a crescent-shaped cross section and is of a harder mixture than the other material of the reinforcing profile is enclosed in the reinforcing profile.

Reinforcing profiles embodied according to the invention thus feature a hard core that is completely surrounded by a softer mixture. The reinforcing profile or its soft mixture can thus absorb the compression tensions occurring in the hard core under stress in case of a breakdown. The hard core profile encased by a softer mixture has the effect of a progressive spring—the stronger the deflection the stronger the resistance. Furthermore, the soft mixture protects the hard core from cracks and offers the added advantage of improving the driving comfort of the tire. The entire reinforcing profile can be embodied more thinly than customary reinforcing profiles, which also has a favorable effect on the driving comfort.

According to a preferred embodiment of the invention, the core profile has a cross-sectional shape that corresponds at least essentially to that of the reinforcing profile. The core profile is therefore embedded in the reinforcing profile such that the wall thicknesses of the reinforcing profile, laterally to the core profile, are at least essentially constant.

The core profile has a preferred Shore A hardness of 74 to 82, in particular of 78 to 81. The Shore A hardness of the reinforcing profile ranges between 60 and 76, in particular between 63 and 66. The modulus of elasticity of the core profile material ranges between 8 and 12 N/mm², that of the reinforcing profile material between 2 and 9 N/mm².

Further features, advantages and details of the invention are described in more detail on the basis of the drawing which diagrammatically represents an exemplary embodiment. The only drawing figure,

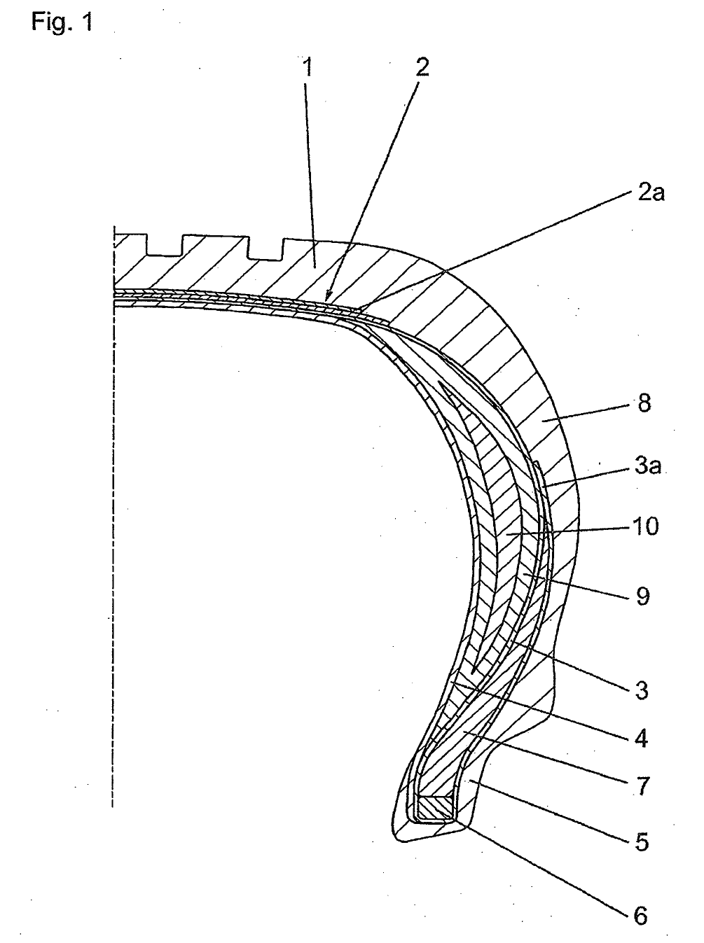

FIG. 1, thereby shows a partial cross section through a radial tire for passenger vehicles.

According to the cross section shown in FIG. 1, the essential components comprising the represented tire are a profiled tread 1, a belt 2 made up of two layers 2a in the embodiment shown, a casing 3 in particular embodied as one layer, an inner layer 4 largely embodied in an airtight manner, beads 5 with bead cores 6 and bead core profiles 7, as well as side walls 8 and approximately crescent-shaped reinforcing profiles 9. The two layers 2a of the belt 2 are composed, in a manner known in particular, of tire cords made of steel cord embedded in a vulcanized rubber mixture, which tire cords run parallel to one another within each layer, whereby the steel cords of the one layer 2a are oriented in a crosswise arrangement to the steel cords of the second layer 2a and in each case enclose an angle between 15° and 30° with the tire circumferential direction. The casing 3 can also be embodied in a conventional and known manner and therefore feature reinforcing threads made of a textile material or of steel cord, which threads are embedded in a vulcanized rubber mixture and run in the radial direction. The casing 3 is guided around the bead cores 6 from the inside outward, with their turn-ups 3a running next to the bead core profiles 7 towards the belt 2.

The two reinforcing profiles 9 produced of an elastomeric material, in particular of a rubber mixture, were positioned on the inner layer 4 during tire assembly and are thus located between said layer and the casing 3. The thickness of the reinforcing profiles 9 decreases both towards the belt 2 and towards the bead 5. Towards the belt 2, each reinforcing profile 9 extends to below the edge areas of the same. Towards the bead 5, each reinforcing profile 9 ends shortly above the bead core 6. Each reinforcing profile 9 is embodied with nearly constant thickness over the major part of the side wall length; here it is up to 13 mm thick, in particular 9 to 11 mm.

Each reinforcing profile 9 contains an elastomeric core profile 10 that is also crescent-shaped in cross section. In the represented embodiment, the cross-sectional shape of the core profile 10 corresponds at least essentially to the cross-sectional shape of each reinforcing profile 9. The core profile 10 extends in the interior of the reinforcing profile 9 in the center region over at least 30%, in particular up to 70%, of the extent of the same between bead 5 and belt 2. Each core profile 10 is thus completely encased by the material of the reinforcing profile, whereby the encasing layer has an essentially constant thickness d between 1.5 and 3 mm.

The represented embodiment is hereby a preferred embodiment; the core profile 10 can also be embodied such that it runs over a smaller or larger part of the extent of the reinforcing profile 9. The core profile 10 can also be arranged displaced towards the belt 2 within the reinforcing profile 9.

It is of particular importance that the vulcanized rubber mixtures of the reinforcing profiles 9 and the core profiles 10 differ from one another in terms of hardness. The reinforcing profile 9 is made of a softer mixture with a Shore A hardness of 60 to 76, in particular 63 to 66 Shore A. The elastomeric mixture from which the core profile 10 is produced has a Shore A hardness of 74 to 82, in particular 78 to 81 Shore A. The modulus of elasticity of the material of the core profile 10 ranges between 8 and 12 N/mm², that of the material of the reinforcing profile 9 between 2 and 9 N/mm². The softer reinforcing profiles 9 thus protect the harder core profiles 10—which are essential for the self-supporting capability of the tire in case of a breakdown—from cracks and improve driving comfort.

In a vehicle pneumatic tire, reinforcing profiles embodied according to the invention can be combined with further reinforcing profiles. It is also possible to arrange the reinforcing profiles in a different manner than shown in FIG. 1, e.g., not on the outside but on the inside of the casing 3.

The reinforcing profiles embodied according to the invention can be produced by means of a duplex extruder.

1. Vehicle pneumatic tire in radial design comprising a profiled tread, a multi-layered belt assembly, an inner layer, a casing embodied in at least one layer, which casing is guided around bead cores in bead areas, side walls and for each side wall at least one reinforcing profile which is inserted in the region thereof, is crescent-shaped in cross section, extends respectively at least over a large part of the side wall length and is made of elastomeric materials of different hardnesses, characterized in that a core profile (10), also with a crescent-shaped cross section, which core profile is made of a harder material than the other material of the reinforcing profile (9), is enclosed in the reinforcing profile (9).

2. Vehicle pneumatic tire according to claim 1, characterized in that the cross-sectional shape of the core profile (10) corresponds at least essentially to the cross-sectional shape of the reinforcing profile (9).

3. Vehicle pneumatic tire according to claim 1, characterized in that the core profile (10) extends over at least 30%, in particular up to 70%, of the extent of the reinforcing profile (9) between belt (2) and bead (5).

4. Vehicle pneumatic tire according to claim 1, characterized in that the Shore A hardness of the reinforcing profile (9) ranges between 60 and 76, in particular between 63 and 66.

5. Vehicle pneumatic tire according to claim 1, characterized in that the Shore A hardness of the core profile (10) ranges between 74 and 82, in particular between 78 and 81.

6. Vehicle pneumatic tire according to claim 1, characterized in that the modulus of elasticity of the material of the core profile (10) ranges between 8 and 12 N/mm², that of the material of the reinforcing profile (9) between 2 and 9 N/mm².
